(19) United States
(12) Patent Application Publication
(10) Pub. No.: US 2025/0061482 A1
(43) Pub. Date: Feb. 20, 2025

(54) System and Method for Adaptive Cross-Coupled Promotion and Content Generation

(71) Applicant: Cadena Platforms LLC, Manhattan Beach, CA (US)

(72) Inventors: Rami Safadi, Manhattan Beach, CA (US); Naveed Ihsanullah, Manhattan Beach, CA (US); Simon Zouki, San Diego, CA (US); Augusto Ariel Aguirre, Montevideo (UY)

(21) Appl. No.: 18/805,826

(22) Filed: Aug. 15, 2024

Related U.S. Application Data
(60) Provisional application No. 63/519,638, filed on Aug. 15, 2023.

(51) Int. Cl. G06Q 30/0242

(52) U.S. Cl. CPC G06Q 30/0244

(57) ABSTRACT

A system and method for automated ad to ad space matching is provided. In some aspects the system and method generate automated digital ad content and modify the same in view of an ad in the context of an ad campaign whereby an analytics unit determines the resulting quantitative performance metrics or objective function resulting from the matching and the content generation steps of the invention. Generation and modification of publisher ad space is also provided in a cross-coupled concurrent fashion that optimizes a goal of the ad placement and promotion. An immutable authenticated environment using blockchain blocks records and provides transparent attribution of the promotion and contents.

### CROSS-REFERENCE TO RELATED APPLICATIONS

This application claims priority to U.S. Provisional Application No. 63/519,638, titled “Adaptive Cross-Coupled Promotion and Content Generation Engines,” filed on Aug. 15, 2023, which is hereby incorporated by reference.

### TECHNICAL FIELD

This application generally relates to systems and methods for secure generation and analysis of promotions and corresponding content.

### BACKGROUND

Current techniques for analyzing generating advertising campaigns lack the desired effectiveness and are not adapted for real-time optimization. Traditional ad campaigns commonly seek to find a best ad space into which to place a given ad in an ad campaign. Sometimes the selection of the ad space is flawed or under-performing. Other times there is no suitable ad space for a given ad and the results are also poor.

Conventional programmatic advertising seeks to automate the exchange in advertising inventory (buying and selling ad space), but is limited in that it merely provides ad placement based on attempted analysis of content user demographics, browsing history, or similar input without a robust consideration of the overall large and small scale context. It further lacks or has limited real-time optimization and suffers from undesirable privacy concerns.

Content management systems (CMS) are also limited in that they are not effectively integrated with advertising systems and suffer from a disconnect between ad placement and content creation and consideration. Various limitations follow from the reliance on static content as well.

Recommendation systems in the prior art attempted to personalize online digital user experiences but are generally limited to product recommendations for promoting e-commerce product sales and are not suited for optimizing ad placement and content and also lack effective cross-platform capability, which results in inconsistent recommendations across platforms and contexts.

The foregoing issues and limitations apply to existing so-called “A/B testing” tools, artificial intelligence (AI) in advertising, and traditional cross-channel marketing platforms which require slow and resource-intensive technologies, lack dynamic or optimization abilities, and have unwanted transparency and privacy detractions.

The disclosure to follow involves a number of parties and components of an adaptive system and method leveraging newly developed technologies that substantially improve the design and operation of such systems and methods for a number of applications including in the field of advertisement analysis and content generation.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

Embodiments of the present system and method overcome some or all of the challenges and limitations discussed above, and provide solutions and technologies that can achieve one or more of the following: Enabling dynamic generation and modification of ad spaces as well as ad content in real-time to maximize the effectiveness of the system and method; seamlessly integrating ad placement and contextually relevant content generation; leveraging artificial intelligence (AI) and machine learning (ML) engines, circuits and processes for holistic optimization across an entire advertising architecture; adapting efficiently to changing market conditions, user needs and preferences, and campaign performance; maintaining user privacy while delivering targeted and effective advertising content in a suitable context; and providing transparency during the design and execution of the promotional campaigns and ad placements.

In one or more aspects, the invention may provide a cross-coupled adaptive system and method that combines real-time ad space modification, dynamic content generation, advanced reinforcement learning techniques, blockchain-based provenance tracking, and cross-publisher attribution. In one or more aspects, the invention may provide the described architecture.

An aspect is directed to a method for optimizing placement of digital advertising content into digital publication content in a secure digital environment, comprising over a digital data communication network coupled to a system data interface, receiving input data from a plurality of input data sources, wherein receiving said input data comprises receiving a digital advertising content from a plurality of advertising content in an advertising content pool and further comprises receiving a digital publication content from a plurality of digital publication contents in a publisher content pool; in a processor of said system, configured and arranged to machine process said input data and stored program instructions, providing said digital advertising content and said digital publication content to a matching engine of said processor, and further determining a match between said digital advertising content and said digital publication content from among the plurality of digital publication contents; in a content generation engine of said processor, concurrently modifying (a) said digital advertising content to generate a corresponding modified digital advertising content and (b) said digital publication content to generate a corresponding modified digital publication content; in an analytics engine of said processor, analyzing said modified digital advertising content and said modified digital publication content using one or more reinforcement machine learning models, whereby said modified digital advertising content and said modified digital publication content are determined to meet a programmed matching criterion; and in a placement module of said processor, placing said modified digital advertising content within a digital environment of said modified digital publication content.

Another aspect is directed to a system for securely provenancing and optimally placing a digital advertising content into a digital publication content, comprising a data interface placing said system in data communication with a digital data communication network coupled to: an advertising content pool, a publisher content pool, and a blockchain environment wherein content in said advertising and publisher pools is provenanced using said blockchain environment; a processor, in data communication with said data interface, the processor comprising logic configured and arranged to programmably execute machine-readable instructions, said logic and instructions comprising a content matching engine, an analytics engine and a content generation engine; said content matching engine coupled and configured to receive said digital advertising content and said digital publisher content and providing an output representing a logical match between said digital advertising content and said digital publisher content; said content generation engine coupled and configured to receive said digital advertising content and said digital publisher content and output from said analytics engine, to modify at least one of said digital advertising content and said digital publisher content to generate a modified digital advertising content and said modified digital publisher content, respectively; said analytics engine coupled and configured to receive an output from said matching engine and at least one reinforcement machine learning module and providing an output representing an advertising effectiveness based on said modified digital advertising content and said modified digital publisher content; and wherein said content generation engine is further coupled and configured to dynamically generate and output a provenanced, optimized and dynamically cross-coupled content comprising said modified digital advertising content and said modified digital publisher content in a space in said digital data communication network.

### BRIEF DESCRIPTION OF THE DRAWINGS

For a fuller understanding of the nature and advantages of the present invention, reference is made to the following detailed description of preferred embodiments and in connection with the accompanying drawings, in which:

FIG. 1 illustrates an exemplary architecture of components of the system and method in an aspect.

FIG. 2 illustrates a content generation and layout engine.

FIG. 3 illustrates an analytics engine.

FIG. 4 illustrates ad pool management.

FIG. 5 illustrates publisher pool management.

FIG. 6 illustrates data coupling arrangements.

FIG. 7 illustrates a reinforcement learning closed loop (RLCL).

FIG. 8 illustrates a reinforcement learning model.

FIG. 9 illustrates reinforcement learning with human feedback (RLHF).

FIG. 10 illustrates integration of reinforcement learning modules.

FIG. 11 illustrates an analytics engine.

FIG. 12 illustrates an exemplary arrangement and method for process optimization.

FIG. 13 illustrates an exemplary architecture which utilizes a blockchain network.

FIG. 14 illustrates an exemplary method for executing a process in an analytics engine.

FIG. 15 illustrates an exemplary process for provenancing on a secure blockchain framework.

### DETAILED DESCRIPTION

This disclosure is generally directed to adaptive systems and method, e.g., implemented in computing environments, networks and related contexts which, in an aspect dynamically optimize advertisement and promotional products and/or the digital medium or content or environment within which they are provided.

The environments described include at least one or more of the following, whether or not they are termed or defined variously. For example in digital advertising (sometimes “ads” for short) comprising the design and creation and analysis of promotional digital materials across various digital, computer, networking and other platforms; digital content generation comprising automated and semi-automated techniques for creating advertising content and/or content within which such advertising content is provided; machine learning and artificial intelligence, especially as it relates to reinforcement learning techniques used to continuously or adaptively or dynamically optimize advertising content to make it more effective; data analytics including the collection, processing and interpretation of large scale data related to advertising performance and user engagement; real-time optimization systems including technologies that allow for immediate adjustments to advertising strategies based on incoming data and performance metrics; digital marketplaces including ad exchanges and platforms where advertisers and publishers interact to buy and sell ad spaces; and user behavior analysis including the study and interpretation of how users interact with digital content and advertisements.

In an aspect, the present invention integrates and optimizes the operation of the foregoing technologies and modalities to provide an effective, efficient and dynamic approach to the generation and placement of promotional content, including in the cross-coupling of ad content and the medium in which it is placed.

In the present context an advertiser is an entity, e.g. a person, government, corporation or interest that seeks to promote goods or services such as brands or products or other items. The advertisers typically design and fund advertisements (ads) or advertising content for presentation through advertising channels and venues to consumers or entities that are exposed to, see, hear, read or otherwise experience the advertising content and are potentially influenced thereby.

An ad agency is an entity, person, company or agent(s) retained by the advertiser(s) to develop and/or manage execution of the ad campaigns. The ad agency may perform creative work, media planning, or other functions with respect to its execution of the advertising effort.

Ad exchanges are digital marketplace(s) where publishers and advertisers buy and sell ad space, which may be physical and/or digital in nature. In some instances this activity is conducted as a real-time auction, for example as in Google Ad Exchange and others.

Ad servers are computer systems (servers) that comprise appropriate hardware circuitry and possibly data and instruction storage units which can execute program instructions and logic and operate on data to accomplish a functionality. The ad servers deliver ads to client devices such as consumer or user devices. Servers can be used by advertisers for campaign management and/or by publishers for ad space management.

Data management platforms (DMPs) are digital platforms that collect, analyze and segment user data, which can be used to optimize and target ads.

Media buying platforms can include demand side platforms (DSPs) and ad networks, which are used by advertisers buying ad space on various media channels. DSPs provide advertisers with automated, efficient buying across multiple ad exchanges.

Publishers refer to owners and corresponding sites such as websites, apps, in-app material and other mediums where ads appear. Publishers sell their ad space to advertisers.

Supply side platforms (SSPs) represent the publishers in the advertising ecosystem. SSPs help publishers to manage and sell their ad spaces to the best suited buyer (e.g., highest bidders in some examples) on an ad exchange.

Users are persons or things that engage with or are influenced by advertising content or ad campaigns. Often, users are end-use consumers who are affected by ads targeting them so as to influence the users' behavior towards the goods, services or other subject matter of an ad campaign.

The relationship between these entities is complex and interwoven. Advertisers work with agencies and DSPs to buy ad spaces from publishers via SSPs and ad exchanges. Publishers use ad servers to deliver the ads to users. DMPs provide the data that helps target these ads better. In an aspect, the goal is that every player uses data and analytics to optimize their efforts and maximize return on investment throughout this process.

In an aspect, the present system and method provide for modifying, evolution of or customizing or optimizing the ad space in view of an intended ad. By this modification or morphing of an ad space based on features or characteristics of the ad to be placed in the ad space it is possible to optimize a desired outcome or result of the ad. For example, in a non-limiting illustration, if an advertiser wishes to maximize a desired metric, parameter or objective (or utility) function for an ad, a suitable ad space can be chosen, modified or even created to do so.

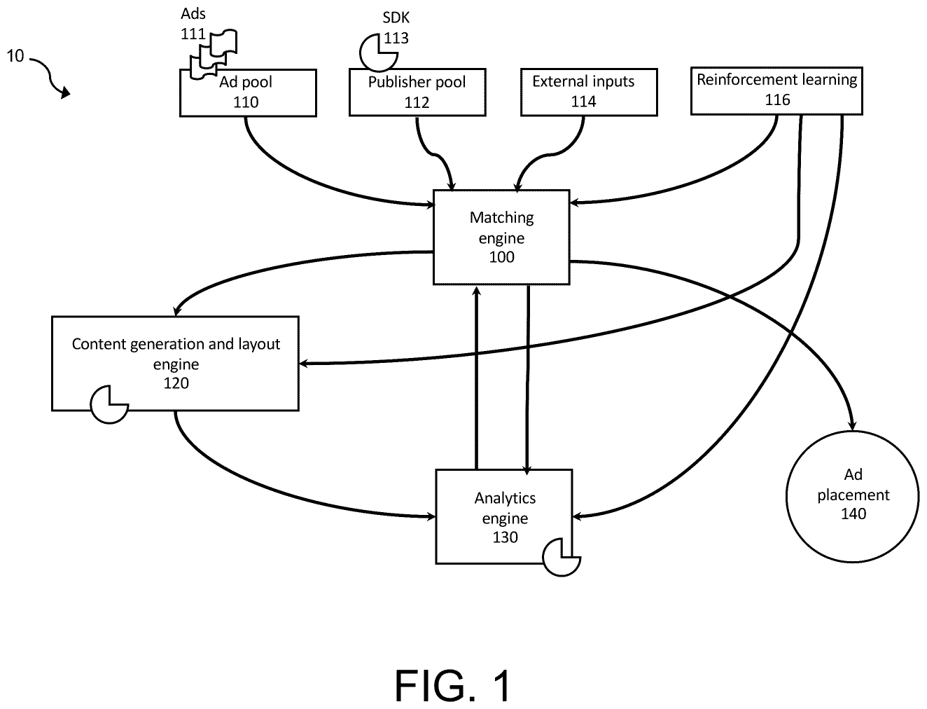

FIG. 1 illustrates an exemplary and non-limiting embodiment of an architecture 10 of the present system and method.

The architecture 10 may comprise a matching engine 100, which assigns ads to publisher spaces based on various factors and optimizations described herein and may be implemented in computing hardware circuitry, programmed machine readable instruction sets, which may further be arranged in any hardware and/or software groupings to achieve a best result for the given implementation. Therefore, the arrangements depicted in this and other figures are to be understood as illustrative, and those skilled in the art will appreciate variations and alternate implementations to best suit their applications and needs. The matching agent is configured and arranged to, inter alia, re-enforce learning with or without human input and which may be performed in a closed loop fashion.

The matching engine 100 receives data and information and signals (inputs) from one or more sources, which can be coupled or remote from said matching engine 100. For example, the matching engine 100 can receive input as ads 111 from an ad pool 110 as well as media content such as any suitable digital or similar content on the Internet or other network or data storage facility or database. The ad pool 110 is updated as ads are deposited into the ad pool. In one aspect, a unique stamp may be issued that uniquely identifies a given ad and serve as an ID of the ad within the context of the invention. The incoming ads are analyzed to identify various features or characteristics of the ads and to extract such aspects of the ads to be used when associating ads and publishers. The ads may be analyzed using machine vision, video, audio, text or other processing methods. Ads 111 may also be deactivated or removed from an ad pool in some instances.

The external inputs can specifically include news content, online trends, social media content and marketplace input data. The inputs may be provided once or may be periodically or continuously be provided as real-time inputs to dynamically enrich and inform the invention. This is indicated by the arrows connecting the various modules of this exemplary embodiment, which represent pathways for moving data, signals or information between parts of the architecture 10.

The matching engine 100 can comprise a processor having circuitry and logic elements (e.g., transistors, microcircuits, logic gates, and related hardware and/or software, data and instructions). The processor can therefore comprise one or more sub-systems such as processing engines, sub-circuits, modules or units that functionally provide one or more functions. These can be configured as described in some of the present preferred embodiments, or as modified or adapted by those skilled in the art to best deliver a desired application. Combinations of commercial processing circuits, program, data and digital logic environments, field programmable gate arrays (FPGA), application specific integrated circuits (ASIC) are all comprehended means of assembling the needed components for carrying out the functions and operations and signal and data processing described throughout this disclosure. Therefore, the matching engine 100, the architecture 10, or any of the disclosed engines, modules and processes can execute a variety of functions. Some examples include but are not limited to: collaborative filtering that identifies patterns in user behavior and ad performance to make recommendations. This may use matrix factorization techniques to handle sparse data efficiently in an aspect; gradient boosting decision trees (GBDT) that provide ensemble learning methods and combines weak prediction models to create a strong predictor, which can be useful for handling heterogeneous features and capturing non-linear relationships in data; deep neural networks, e.g., Siamese network architecture, which can be used to learn a similarity function between ads and publisher spaces. These networks may comprise a pair of substantially identical sub-networks processing the ad and publisher space features separately, with each respective output combined with the other to produce a similarity score; and Thompson scaling, which provides a probabilistic method to balance exploration and exploitation in ad selection, efficiently handling the exploration-exploitation tradeoff in real-time decision making.

The matching engine 100 can assign one or more ads from an available ad pool to one or more publishers from a publisher pool 112, which includes available publishing spaces where ads can be placed. This can be done either randomly, in a round-robin rotation, or based on some logical distance measure between the ad and the publisher's subject matter, e.g., semantic distance or vector embedding. The publisher pool 112 can be updated as publisher spaces are deposited into the ad pool. In one aspect, a unique stamp may be issued that uniquely identifies a given publisher space and serve as an ID of the publisher space within the context of the invention. The incoming publisher spaces are analyzed to identify various features or characteristics of the publisher space and to extract such aspects of the publisher spaces to be used when associating ads and publishers. The publisher spaces may be analyzed and extracted using for example linguistic and other analysis tools looking at names, content subject matter, layout information or other data.

The invention may comprise a publisher analytics software development kit (SDK) 113. This module or agent can collect relevant data such as the number of views of a site or content, length of stay by a visitor to a site, number of click-through results, or other information. The data can be used to evaluate the performance of the invention and evaluation of the reinforcement learning steps. The publisher analytics SDK 113 can be embedded within the publisher environment or a corresponding application program interface (API). In an aspect the publisher analytics SDK 113 provides data from the publisher to the analytics engine 130. A publisher site can be deactivated in some instances and removed from the publisher pool 112.

Recommended content creation and generation and layout using a reinforcement learning subsystem or engine 116 is another aspect of some embodiments. Reinforcement learning with human feedback (RLHF) is an example where a human evaluates the automated recommendations for the suggested generative content. Reinforcement learning closed loop (RLCL) is another example where no human involvement is required. Reinforcement learning subsystem 116 continuously improves the performance of the matching engine 100, content generator 120 and analytics engine 130 through machine learning steps executed in said reinforcement learning subsystem or engine 116.

The matching engine 100 can be configured and arranged to optimize, maximize and best fit the matched ad-publisher space arrangement to a desired metric, parameter or objective (or utility) function, or combination thereof. This can be accomplished by using known optimization algorithms or methods including as implemented in computing apparatus hardware, software or combinations of the same.

The matching engine 100 may receive inputs from and interacts with an analytics engine 130 as well as from the various external data sources described herein. Other data sources can include any economic data, sensor output data, point of sales, imaging device outputs (cameras placed in locations of interest), market data (streamed from marketplaces dynamically) or other data sources.

The invention also employs a content generation and layout engine 120, which can be in an embodiment described with a content generation and layout agent (again, implemented using hardware and/or software as suits a specific instance). The content generator 120 can include several mechanisms for content generation using tools and resources such as manual (human) generation, machine automated generative AI based on topic domains, generative with human guidance or input, and recommendation from the matching engine 100.

The content generator and layout engine 120 can determine the manner in which generated content is used, placed in an ad space or laid out and presented for best effect. This engine, module or process can employ natural language methods, computer vision methods and others. In some aspects and non-limiting examples, this may comprise and support one or more of: transformer-based language models, like generative pre-trained transformer or GPT for text generation, fine-tuned on advertising copy and contextual content; variational autoencoders (VAEs) that are used for generating and manipulating visual content, allowing for the creation of context-appropriate images; attention mechanisms, which may be implemented in text and/or image generation to ensure generated content remains relevant to the ad and surrounding context; and generative adversarial networks (GANs) which are used for creating realistic, high-quality images that complement the textual content.

Analytics engine 130 may comprise a publisher analytics software development kit (SDK) coupled to said content generator. This agent can collect relevant data such as the number of views of a site or content, length of stay by a visitor to a site, number of click-through results, or other information. The data can be used to evaluate the performance of the invention and evaluation of the reinforcement learning steps. The SDK 113 can be embedded within the publisher environment or a corresponding application program interface (API) in some non-limiting examples. Optimized digital ad content placement into corresponding digital publisher content space at 140.

The architecture 10 in an exemplary embodiment can thus include: an interface to an ad pool supply; an interface to one or more publisher entities and frameworks; a matching agent or unit to match ads and publishers; an automated or partially automated content generator; an optimizer that finds a best ad for an ad space based on one or more objective functions or metrics; a tracker that tracks and monitors and/or quantifies the performance of the ad-content combination; and a trainer that trains and dynamically updates the operation of the system and method.

The architecture 10 can be implemented in a variety of ways understood by those of skill in the art, and not necessarily limited to the shown embodiment. For example, functions and components described may be incorporated into common blocks (logical, circuits or combinations) or broken up into separate functional units as desired by those making a given implementation, all of which are intended to fall within the scope of this invention.

In another aspect, the invention may be automated, sometimes with use of machine-generated content or human-assisted automated content generation. The content can thus be used in an ad space where the ad can find the desired result as mentioned above. The content can be updated and if needed revised from time to time or continuously to suit the desired outcome or to maximize or optimize the effect of the ads within the content.

In yet another aspect, both the ad and the content of the ad space can be simultaneously generated, or optimized for one another in a natural way that results in the best possible performance of an ad campaign as measured by one or more metrics or objective functions. Therefore, the generated content and/or ad can be considered dynamic and can change as desired in time.

Since the operation of the system and method may rely on machine learning and automation methods, training data may be drawn from any existing useful source including initially from existing traditional advertising data and performance results. Over time, the system and method may be configured to include real-time performance results from an ongoing ad campaign, which can be used as further training or learning source data for the same or other ad campaigns using the invention.

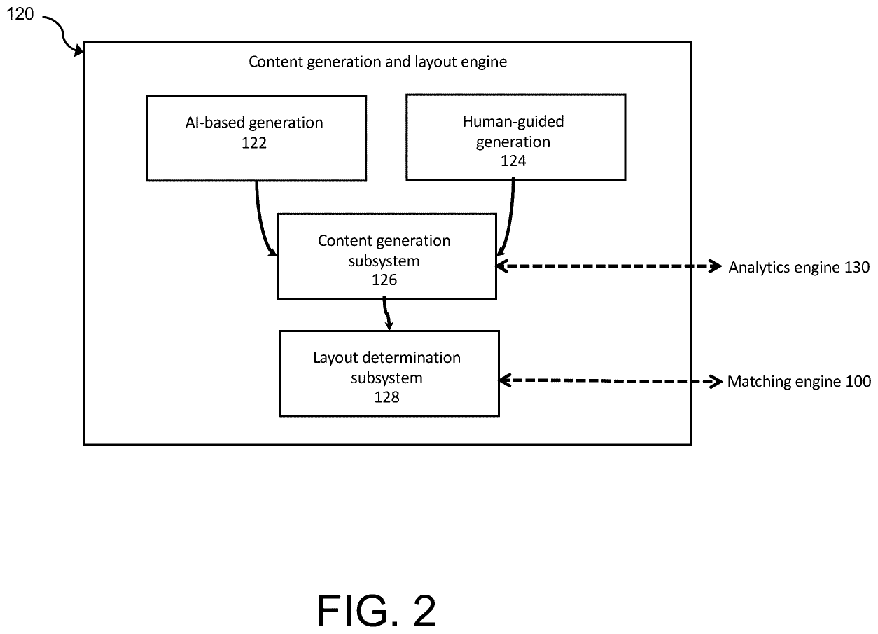

FIG. 2 illustrates a more detailed view of an exemplary content generation and layout engine 120 according to one or more embodiments. The content generation and layout engine 120 may be organized into or comprise one or more of an artificial intelligence (AI) based generation module 122 which utilizes machine learning models for automated content creation; a human-guided generation module 124, which provide results and data output to the content generation subsystem 126, which allows manual input and refinement of generated content. The content generation subsystem 126 may further be in data communication with or coupled by signal pathways to analytics engine 130. In addition, the content generation subsystem 126 is coupled to a layout determination subsystem 128, which provides content layout functionality. In some aspects, the layout determination subsystem 128 determines optimal placement and presentation of ads and generated content, and adapts layout of such content based on inputs from the matching engine 100 and analytics engine 130. It is again stated that the logical depictions in the illustrated embodiments here are one possible configuration and arrangement of these aspects of the invention, which can be configured or arranged in other equivalent ways as best suits an implementation.

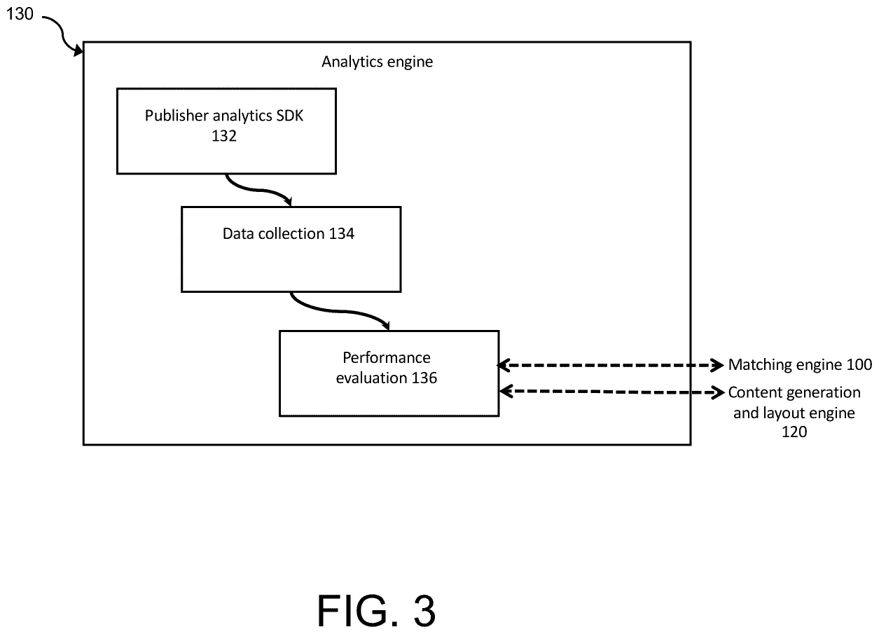

FIG. 3 illustrates a more detailed view of an exemplary analytics engine 130 according to one or more embodiments. The analytics engine 130 may be organized into or comprise one or more of a publisher analytics SDK 132 embedded within the aforementioned publisher environments; a data collection module 134 which collects relevant information (data) needed by the analytics engine and components; and a performance evaluation module 136, which may be coupled to matching engine 100 and/or the content generation and layout engine 120.

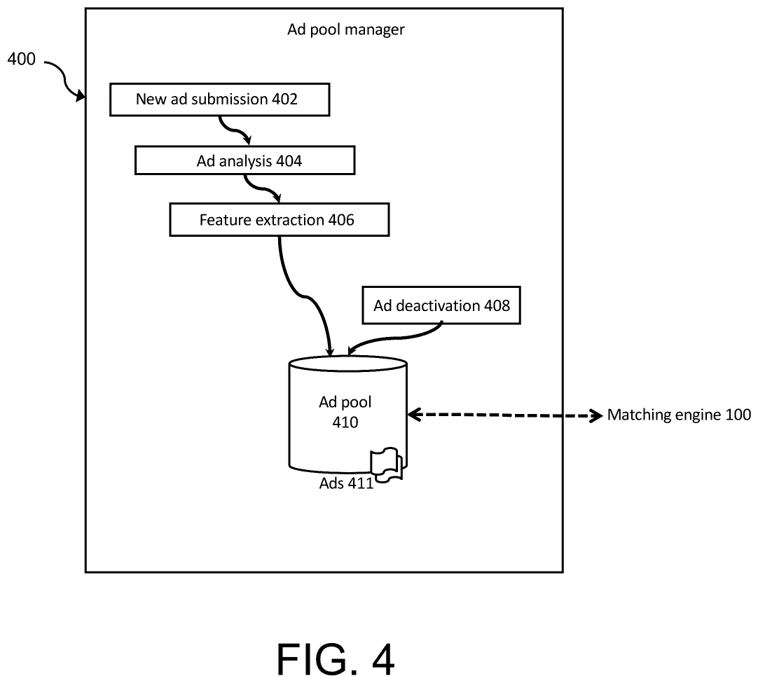

FIG. 4 illustrates an exemplary embodiment of ad pool management methods and engines, which can comprise associated subsystems or modules. In the non-limiting example the ad pool manager 400 in this example, a new ad submission module or step 402 is configured and arranged to receive a plurality of new ads 411, which may be stored in an ad pool 410 including an ad pool database, data store or digital storage medium. New ad submissions 402 are provided to an ad analysis module or step 404 which is configured and arranged, including by executing machine readable instructions programmably to determine one or more metrics or analysis results. Additionally, one or more features of the ads may be derived, isolated, identified or extracted using a feature extraction module or step 406. Any results of the analysis or feature extraction can be stored in a data store as stated, which may be the same or with or coupled to ad pool 410. Exemplary features may include content type, target audience, visual elements of the content or others. In an aspect, the ad pool manager 400 and/or ad pool 410 are in data communication or coupled to the matching engine 100. In an aspect, one or more ads 411 can be deactivated upon determination by ad deactivation module or step 408. Ads 411 can be removed from the active ad pool 410, e.g., by changing an ad property from being active to being inactive, if and once such ads are expired or determined to be no longer relevant or active.

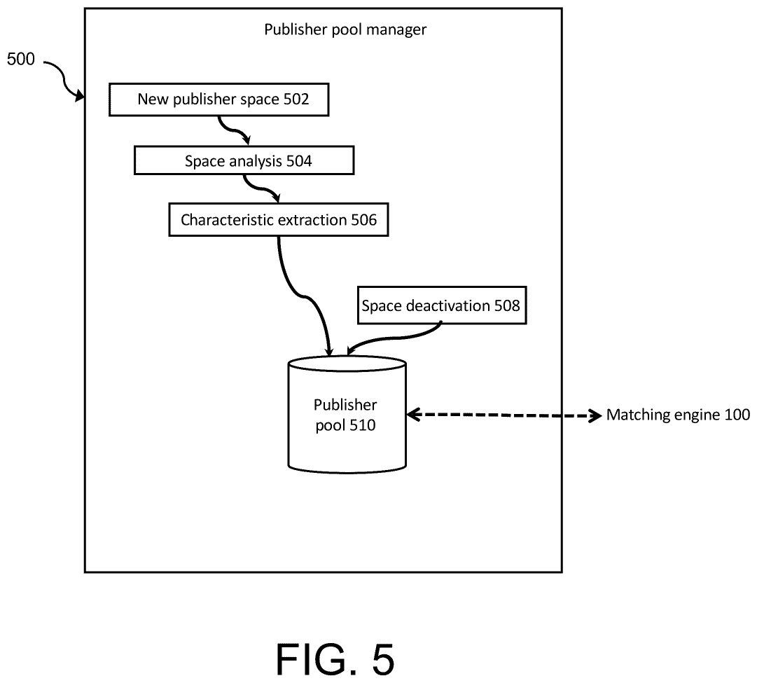

FIG. 5 illustrates an exemplary embodiment of publisher pool management methods and engines, which can comprise associated subsystems or modules. In the non-limiting example the publisher pool manager 500 in this example, a new publisher space submission module or step 502 is configured and arranged to receive a plurality of new publisher spaces, which may be stored in an a publisher pool 510 including an ad pool database, data store or digital storage medium. New publisher space submissions 502 are provided to a publisher space analysis module or step 504 which is configured and arranged, including by executing machine readable instructions programmably to determine one or more metrics or analysis results. Additionally, one or more characteristics of the publisher spaces may be derived, isolated, identified or extracted using a characteristic extraction module or step 506. Any results of the analysis or characteristic extraction can be stored in a data store as stated, which may be the same or with or coupled to publisher pool 510. Exemplary characteristics can include publisher space size, placement on a page, page content such as surrounding text and graphics, and others. In an aspect, the publisher pool manager 500 and/or publisher pool 510 are in data communication or coupled to the matching engine 100. In an aspect, one or more publisher spaces can be deactivated upon determination by publisher space deactivation module or step 508. For example, a publisher space can be deactivated, e.g., by changing its property from being active to being inactive, when the space is no longer available.

The foregoing ad pools and publisher pools may continuously interact with the matching engine and system over a data communication port or interface, wherein the system is in data communication with the needed data input sources over such a network as suits the application at hand. In some aspects, the matching engine, module or process of the invention retrieves or receives digital ad content from ad spaces, receives digital publisher content from publisher pools for matching therebetween along with optimization of these resources as disclosed herein. Feedback may be provided in some examples from the matching engine to other parts of the system and method to update the status or characteristics of ads and publisher spaces in the respective pools based on performance data, performance measurements or performance criteria.

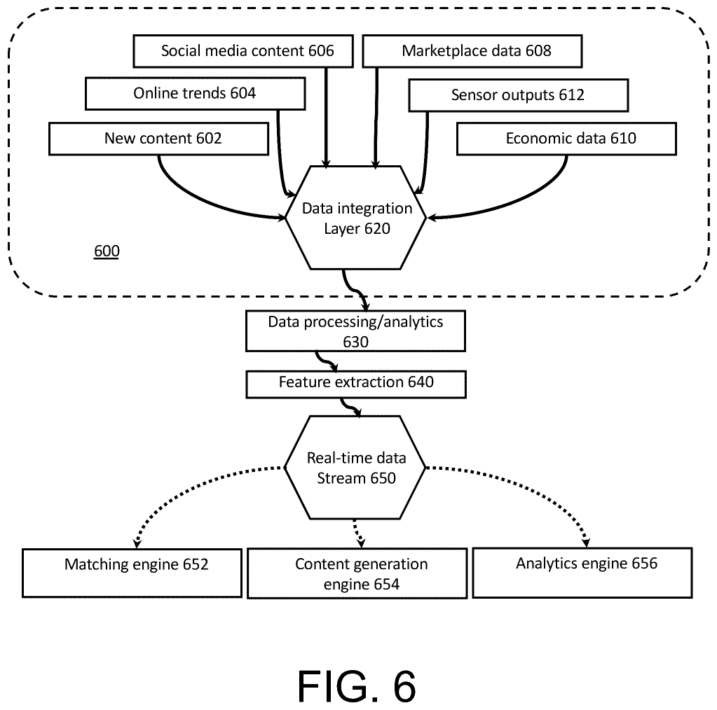

FIG. 6 illustrates some exemplary data coupling arrangements and ways that the invention may take and manage information in some embodiments. In the illustrative non-exhaustive example, the system and method can take information from external data sources 600 including one or more of: new content 602 relating to, e.g., current events that may influence ad relevance; online trends 604 relating to popular search terms, topics, hashtags, and viral content; social media content and channel feeds 606 representing user-generated content, group discussions, and sentiment analysis; marketplace data sources 608 corresponding to real-time information on product availability, pricing, and demand; economic data 610 relating to broader economic indicators impacting consumer behavior; and data from sensors 612. The sensor data can include a large variety of types of data and internet-of-things (IoT) sensors such as environmental, data network, physical sensors, medical, industrial, geological, weather and any other apparatus or sensor that generates a usable output responsive to and corresponding to a sensed input of said sensor.

The received inputs are provided to a data integration layer, module or step 620. This layer 620 harmonizes the various data input streams 600 into a consistent format and handles data validation, cleaning, and initial preprocessing. The data integration 620 is processed by a data processing and analytics module as suits a given implementation at data processing and analysis engine or step 630, which in an aspect determines and/or prepares data to be provided to the analytics engine 656 through real-time data stream 650. Here further data processing and some analysis is performed to determine meaningful insights, which can include natural language processing, sentiment analysis, trend detection, and advanced analytics techniques. Features of the integrated and processed data are identified and extracted at feature extraction module or step 640. The extracted features can be directly relevant to ad matching and content generation. A real-time data stream 650 receives any needed information after processing and feature extraction and provides in turn useful data output information to one or more of a matching engine 652, which uses received data to inform ad-publisher pairing decisions and optimization; content generation engine 654, which incorporates current trends and relevant information into generated content; and analytics engine 656, which utilizes external data or other information to provide context for performance metrics and to enhance predictive capabilities of the system and method.

Being at least partly machine-implemented or assisted, the present systems and methods preferably include and operate using specialized computing hardware, which can vary significantly from one implementation to another depending on the needs of a given application or user. The same can be said for the software, data, data storage means, methods and processes associated with the foregoing architecture. In some aspects, the system and method includes high performance servers such as a distributed cluster of high performance computing machines that handle the computational demands of the system and method. These may be equipped with server-grade central processing units (CPUs) having high core counts for parallel processing capabilities if necessary. Also, general processing units (GPUs) and clusters of GPUs may be used to accelerate machine learning and AI operations. These may use GPU virtualization techniques to efficiently allocate GPU resources across different tasks.

A distributed data storage infrastructure is also an aspect of some embodiments. These may implement a combination of high-speed SSD storage for frequently accessed data and large-capacity HDD storage for archival data storage purposes. In some aspects, distributed file systems (e.g., Hadoop distributed file systems) may be employed for scalable and fault-tolerant data storage.

As far as the computer programs, machine-readable instructions and software facets of the system and method, they may be implemented in a variety of suitable programming environments, languages and means. Any such implementation is comprehended by this disclosure and invention and may be chosen by those skilled in the art to meet their particular scenario and needs. A software stack in a non-limiting example may include one or more of: an operating system, e.g., Linux-based or other system optimized for high-performance computing and real-time operations; containerized and orchestrated software implementing, e.g., Docker technology for containerization of system components, or using Kubernetes for orchestrating and managing the deployment of containers across a computing cluster; distributed computing frameworks, e.g., using Apache Spark or similar technologies for large-scale processing and machine learning tasks, and Apache Flink or similar technologies for real-time stream processing; machine learning libraries, e.g., using TensorFlow and PyTorch for deep learning model development and deployment, or scikit-learn for traditional machine learning methods; database management employing a combination of relational (e.g., PostgreSQL) or NoSQL (e.g., Cassandra, MongoDB) databases to handle different data types and access patterns, or using Redis for in-memory caching of frequently accessed data; message queueing systems, e.g., Apache Kafka for high-throughput, fault-tolerant message queueing between system components; and API management using a suitable API gateway, e.g., Kong, Apigee, to manage, secure and monitor API access to the system.

We next describe some exemplary learning models and implementations, which may be used separately or in combination with one another or other compatible models and implementations as best suits an application. The system and method can switch between more than one learning implementation or combine the learning implementations, including balancing automated (machine) and/or human-assisted implementations. Dynamically updating or adapting the learning models and implementations can allow for continuous improvements in ad placement and content generation, adapt to changing user preferences, and achieve a balance of creative and performance-driven approaches to advertising.

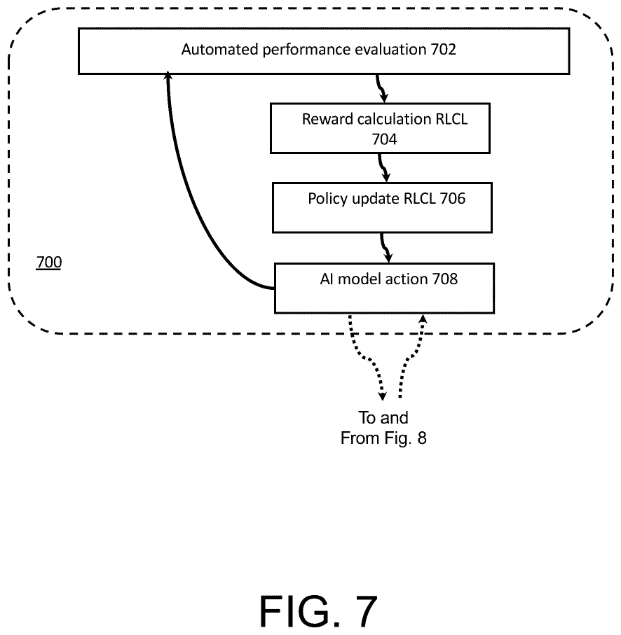

FIG. 7 illustrates an exemplary reinforcement learning closed loop (RLCL) model 700 as referenced herein. The RLCL model may operate autonomously, using automated performance metrics to drive the learning process. In illustrative RLCL implementation includes an automated performance evaluation module or step 702; a reward calculation RLCL module or step 704, which automatically calculates a reward based on predefined performance metrics as in 702; a policy upgrade RLCL module or step 706 that determines or updates the system's policy based on the calculated rewards as in 704; and artificial intelligence (AI) model action module or step 708, which automates the placement of ads autonomously. The RLCL implementation 700 enables rapid, continuous optimization without (or substantially without) human intervention and review. It also scales efficiently to handle large volumes of ad placements and content generation. Furthermore, this implementation can be effective for optimizing objectives and quantifying metrics. The RLCL implementation 700 can be integrated with other learning models and implementations if desired.

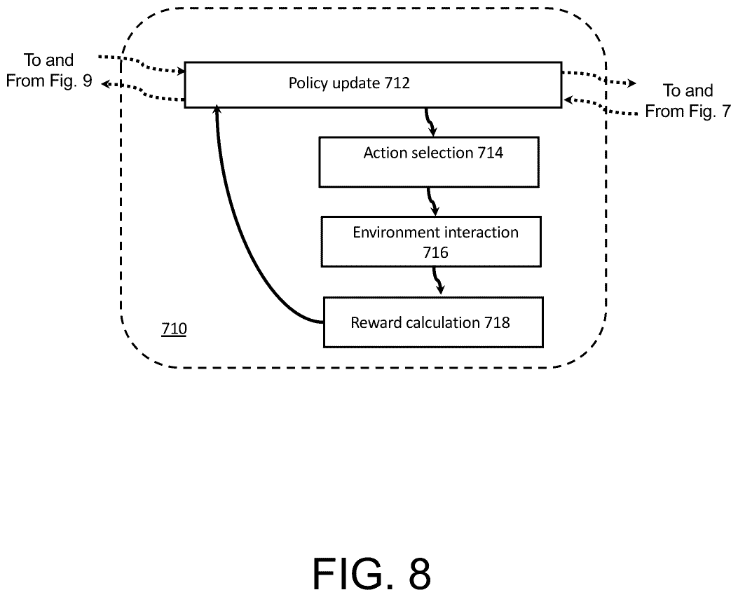

FIG. 8 illustrates an exemplary non-limiting reinforcement learning model 710 comprising a policy update module or step 712 that updates a policy based on, e.g., rewards received and which may maximize or increase future rewards; an action selection module or step 714 that chooses actions, e.g., ad placement, content generation, based on its current policy; an environment interaction module or step 716 where actions are executed in a real world environment and ads are presented to actual users; and a reward calculation module or step 718 based on feedback in the form of rewards, e.g., click-through rates and conversion rates.

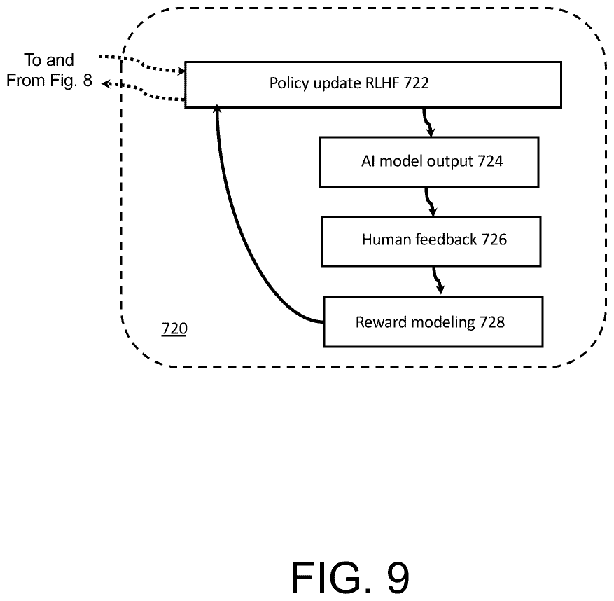

FIG. 9 illustrates an exemplary non-limiting reinforcement learning with human feedback (RLHF) model 720. This model thus employs a combination of machine and human efforts where a human operator or expert can guide the machine driven process, especially regarding subjective aspects of ad placement and content generation. Here an AI model output module or step 724 uses AI for generating ad placement and/or content. Human feedback module or step 726 enables human evaluators to provide feedback on the quality and appropriateness of the system's output. At reward modeling module or step 728 the human feedback from 726 and converts this to a reward output, data or signal. The policy update RLHF 722 is updated based on the human-derived rewards. RLHF 720 thus incorporates subjective human judgment on ad quality and appropriateness, helps align the system's outputs with human preferences and values, and is particularly useful for creative aspects of content generation.

Content generation can be adaptive and take into consideration by way of input data or programmed rules various parameters. Style transfer techniques are an aspect of some embodiments to generate content using visual or textual styles or brand aesthetics as desired.

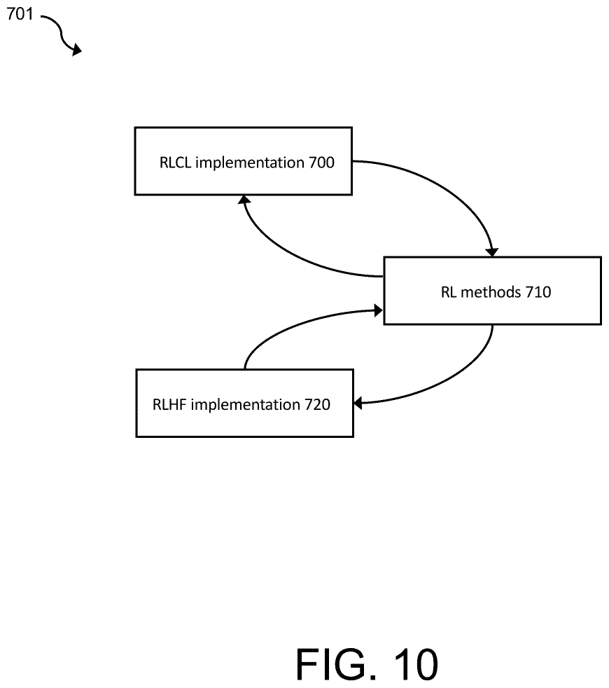

FIG. 10 illustrates a non-limiting example of the integration of reinforcement learning modules and methods 701 in one or more embodiments. As seen in the foregoing examples, the system and method can integrate RLCL implementations 700, reinforcement learning models 710 and RLHF implementations 720 in an overall architecture 701 to achieve a desired result. These reinforcement learning modules and sub-modules or methods can be applied as needed in a given implementation of the present system and method, which can include one or more of the specific implementations described by way of illustration, or a combination thereof.

In any or all of these examples, the system and method may further comprise or implement a dynamic pricing engine, module or process to identify an appropriate pricing for ad placement based on demand, performance and other metrics. In a converse sense, the system and method may use an agreed price as a fixed input parameter and determine the placement, content and operations of the system and method based on the known price given.

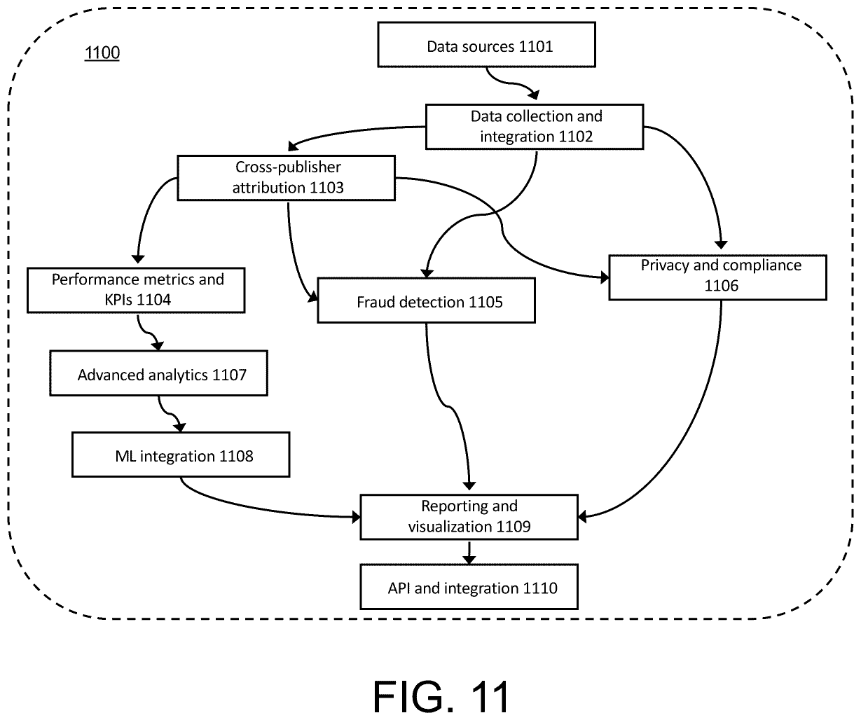

FIG. 11 revisits the present discussions of the analytics engine 1100 and its architectures and methods in various exemplary embodiments. As seen, a variety of data sources 1101 provide inputs and information and data to the system and method, e.g., the analytics engine 1100. The data source(s) 1101 can include one or more of ad servers, publisher platforms, and user interaction points. The data collection and integration module or step 1102 ingests the data from the data sources 1101 and aggregates needed data therefrom, including blockchain-based provenance data. The cross-publisher attribution module or step 1103 implements advanced attribution models to track and credit user interactions across different publishers and platforms. Performance metrics and KPI module or step 1104 is concerned with key performance indicators (KPI) and calculates standard and custom metrics that reflect the value of each touchpoint in a user experience. Advanced analytics module or step 1107 employs techniques such as predictive modeling, anomaly detection, and cohort analysis to derive deeper insights. Fraud detection module or step 1105 analyzes cross-publisher data to identify potential ad fraud and collaborates with the blockchain-based provenance for data verification. In an aspect, the provenance features comprise provenance data integration, which may include verified and transparent facts regarding the history of each advertisement content's life cycle, extracted from the blockchain because the system and method securely create time stamps, modification history data, and a record of all placements and interactions with the content.

Privacy and compliance module or step 1106 implements data protection measures and ensures regulatory compliance across different publisher jurisdictions. Machine learning (ML) integration module or step 1108 continuously trains and updates models using cross-publisher attribution data to optimize ad placements and content. Reporting and visualization module or step 1109 generates real-time dashboards, interactive user interfaces and exploration tools, and automates reports with natural language insights for the benefit of users. The API and integration module or step 1110 provides capabilities for seamless integration with external tools and platforms. The exemplary figure illustrates how an embodiment logically configures the modules of the engine 1100 with respect to one another, and how the corresponding method steps can be taken in the associated procedure.

This architecture and method provides cross-publisher analytics and reports while maintaining provenance and privacy, detecting fraud, and providing actionable insights for optimizing advertising campaigns. Cross-publisher optimization may be provided by the system and method.

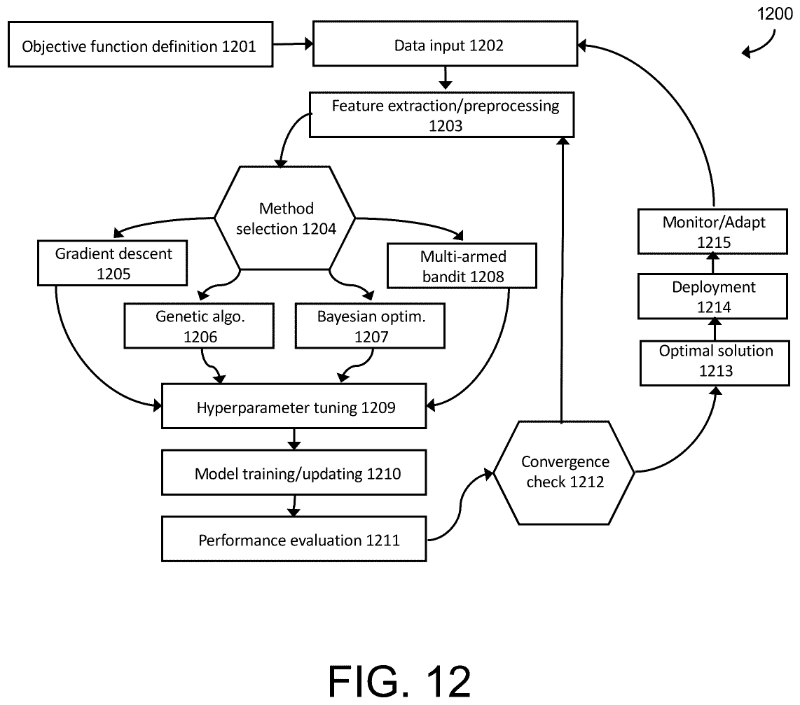

FIG. 12 illustrates an exemplary arrangement and method 1200 for optimization of the processes used for one or more exemplary non-limiting embodiments. An objective function definition is provided at 1201, in which the system defines objectives such as maximizing click-through rates, conversion rates, or user engagement. Multiple objectives may be defined and combined into a single utility function in some aspects. Pareto optimization techniques may be used in some embodiments. Data input takes place at 1202. Relevant data from various sources are collected and preprocessed. Feature extraction techniques are applied to identify key variables influencing ad performance. Feature extraction and any helpful preprocessing of the input data is performed at 1203. A method or algorithm (which may be embodied in a machine-readable and executable program instruction set, hardware or combination of those) is carried out at 1204. For example, gradient descent 1205 may be selected for continuous optimization problems which efficiently finds local optima in high-dimensional spaces; genetic algorithm 1206 may be used as inspired by natural selection and which is useful for complex non-linear optimizations, especially for exploring diverse solution spaces; Bayesian optimization 1207, efficient for optimizing expensive-to-evaluate functions and balances exploration and exploitation in the solution space; or multi-armed bandit method 1208, which can be helpful for balancing exploration of new strategies with exploitation of known effective ones, especially in real-time ad placement decisions. These are followed by a hyperparameter tuning 1209. This can be used for meta-optimization to fine tune parameters of selected algorithms, and ensures optimal performance of the optimization algorithms themselves. Then, the process carries out any needed model training or updating at 1210. Performance evaluation (e.g., quantifying metrics) are carried out at 1211. Cross-validation methods may be employed here to ensure overall system and process robustness.

At an appropriate step, e.g., after model updating 1210 and performance evaluation 1211, a convergence check can be performed at 1212 whereby the system checks if the optimization process has converged to satisfy a solution (within defined limits). If no convergence is reached, the process loops back for further iteration. Depending on the results of the convergence check 1212, the process 1200 may return to feature extraction and preprocessing 1203, or, it may determine an optimal (optimized) solution at 1213. After which deployment takes place at 1214 so that an optimal solution is deployed by the system. This is followed by continuous monitoring or adaptation at 1215 to create a continuous feedback closed loop, which provide input in turn to data input block 1202.

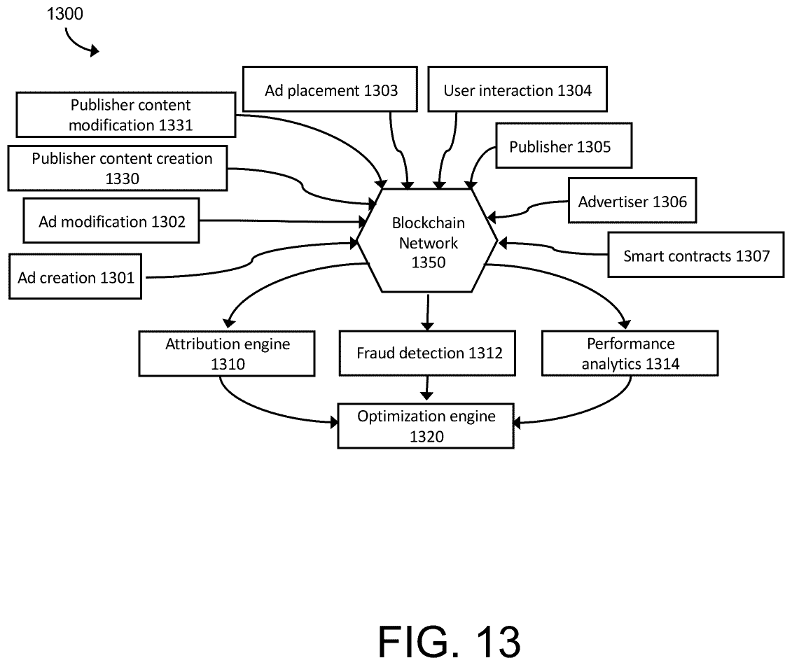

FIG. 13 illustrates an exemplary architecture 1300 in some aspects of the invention, which utilize a blockchain network 1350 that can include, comprise or share resources with a data communication network such as the internet or another wide or local network. The blockchain network holds and can be provided with secure blocks enabling provenancing of content and other data. Examples of information that can be included in such provenancing steps and blocks includes: ad creation blocks 1301, ad modification blocks 1302, publisher content creation blocks 1330, publisher content modification blocks 1331, ad placement blocks 1303, user interaction blocks 1304, publisher blocks 1305, advertiser blocks 1306, and smart contracts 1307.

In an aspect, a new asset is created on the blockchain responsive to an event relevant for the transparent secure and provenanced transactions it supports. Such assets receive a unique asset ID and are recorded in the blockchain. A genesis block is created in an aspect for a given asset. Upon the occurrence of a transaction, e.g., when an asset is transferred or modified, such new transactions are validated and verified. If they are found valid, a new block is created and added to the blockchain. If they are found not valid, the transaction is rejected and the process returns to the transfer/modification step. In an aspect, relevant interested parties are notified of such block creation and updates, e.g., to notify of the new transaction. The present provenances may be queried, which retrieves and verifies the blockchain data before presenting the provenance results.

The blockchain network 1350 may be used to authenticate, secure and provenance information and outputs provided to other parts of the present system and method, including to the attribution engine, module or process 1310, fraud detection engine, module or process 1312, and performance analytics engine, module or process 1314. In some embodiments, an output from the foregoing engines, modules or processes 1310, 1312, 1314 may be provided as inputs to a coupled optimization engine, module or process 1320.

The data communication network and communication of information encoded in digital signals over communication links and pathways of said network may comprise proprietary or standardized techniques, or combinations thereof. For example, the system and method's data exchange and transport over such networks may comprise one or more of: content delivery networks (CDN) integrated to ensure fast delivery of ad content to users across geographical locations; real-time bidding (RTB) protocols, e.g., implementing Open RTB protocols for real-time bidding interactions with ad exchanges; data transfer protocols, e.g., using gRPC for efficient, low-latency communication between internal system components, or implementing GraphQL for flexible, efficient data querying from client applications; and security protocols, e.g., using TLS/SSL encryption for data transmission, or implementing OAuth and JWT or similar means for secure authentication and authorization. It should be understood, as with the present disclosure of preferred or exemplary software and hardware examples, that these are merely provided for the sake of better understanding and description of some aspects of the exemplary embodiments. Those skilled in the art will appreciate that equivalent or derivative or future versions or similar means may be substituted for any needed functionality provided by the exemplary illustrations.

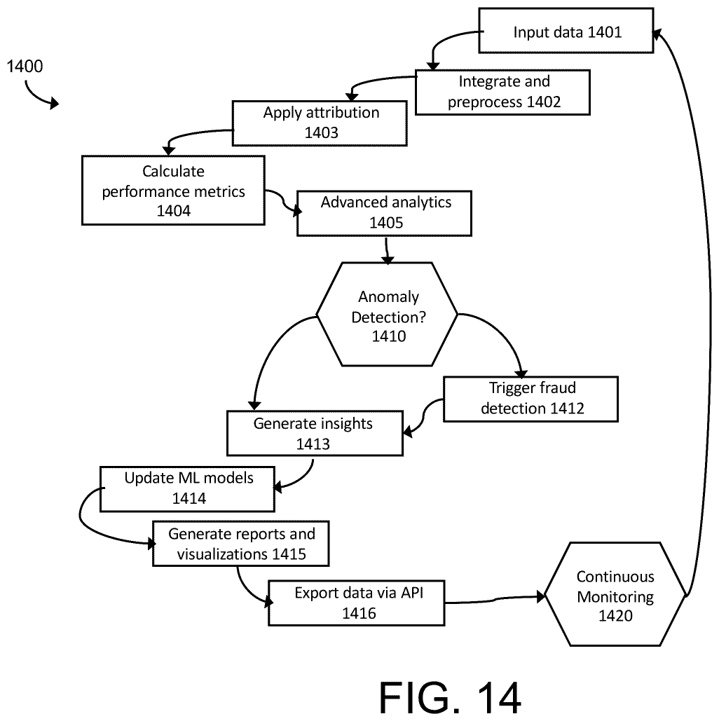

FIG. 14 illustrates an exemplary method for executing a process in an analytics engine according to a non-limiting embodiment 1400. The system and method receive data from one or more sources at 1401. The data is integrated and preprocessed at 1402. A cross-publisher attribution is applied at 1403. Performance metrics are calculated at 1404. Advanced analytics 1405 receive said performance metrics and provide a corresponding output of said analytics to anomaly detection 1410. If an anomaly is detected at 1410, the system and method trigger fraud detection measures, messages or other protective steps at 1412. Insights are generated at 1413, and machine learning model(s) are updated or changed at 1414. Reports and visualizations aiding users are prepared and output at 1415. Data is exported as appropriate in a format as needed via an application program interface API at 1416. Continuous monitoring of all this activity and data and outputs is performed at 1420, and the process continues.

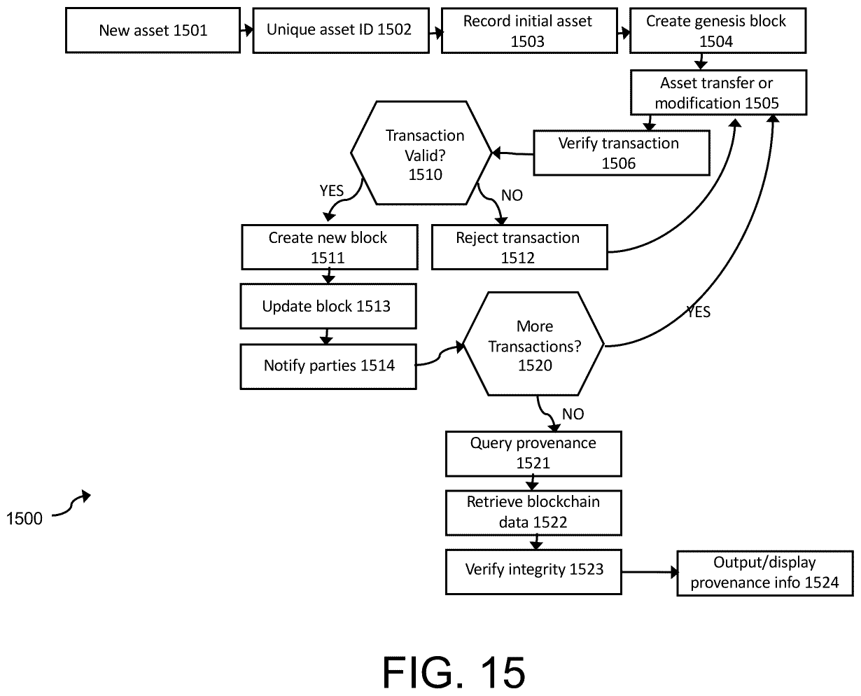

FIG. 15 illustrates an exemplary process 1500 for provenancing on a secure blockchain framework as employed by the present system and method in some aspects. A new asset is created at 1501. Generally, the asset may be either or both of a digital ad content asset or a digital publisher content asset. The asset is allocated a unique identifier ID at 1502. The asset is further recorded as an initial asset data at 1503. This is performed by creating a genesis block in the blockchain at 1504. Asset transfers or modifications are recorded at 1505. Any transactions related to the asset are noted and recorded at 1506. The system and method determine whether a transaction in the asset is a valid one at 1510. If valid, a new block is created in the blockchain at 1511. If not valid, the transaction is rejected at 1512 and other actions taken or reported. The blockchain is updated at 1513. Interested parties are notified at 1514.

If further transactions are required or occur at 1520, the process returns to 1505. If no further transactions occur then the provenance is queried at 1521. The blockchain data is retrieved for this operation at 1522, and its integrity is verified at 1523. Finally, the system and method may output or provide or display the results of the provenancing at 1524.

As an illustration of the breadth and flexibility of applications benefiting from the present system and method we may consider a few examples to aid those skilled in the art to appreciate the uses of the invention and enable them to apply the invention to other problems in their field of use.

Consider an online retailer wishing to promote a new line of eco-friendly products. The system and method (e.g., matching engine) identifies potential ad spaces on environmentally-focused websites and social media platforms. The system and method dynamically modifies these spaces (e.g., using the content generation engine) to better showcase the product's eco-friendly features. The content generation engine further creates ad copy content emphasizing sustainability, while simultaneously generating surrounding content about environmental conservation, and where making modifications to existing content, creating modified content. The analytics engine of the system and method monitors user engagement with the ad and publisher digital content, tracking metrics like click-through rates or time spent by users viewing ad content. The system and method's reinforcement learning engine, module or process then adjusts the strategy in real-time, possibly emphasizing certain product features that gave desired engagement with the audience. As external data shows a trend (e.g., through a hashtag) related to the environmental issue, e.g., climate change, the system and method dynamically incorporates this into the ad content and surrounding publisher content (text or web page) to increase relevance and engagement. The system and method thus generate and optimize a paired ad content-publisher content digital environment using the present machine learning and AI methods to maximize the desired impact of an ad in a publisher space.

In another example, consider a scalable blockchain-based provenance tracking process for multi-channel ad campaigns. For example, a consumer electronics brand intends to launch a new product (e.g., a smartphone) with a multi-channel digital advertising campaign across various publishers, social media platforms, and ad networks. Here, the system and method may create a unique blockchain entry (genesis block) for each ad creative in the campaign, including metadata such as brand information, campaign ID, and initial targeting parameters. Each placement, impression, click, and conversion related to each ad is recorded as a new block in the blockchain, creating an immutable history of the ad's performance across all channels. The content generation engine creates dynamic, context-aware variations of ad content based on real-time performance data and blockchain-recorded user interactions. The matching engine optimizes ad placements across various platforms, considering factors such as historical performance data stored in the blockchain, current market trends, and target audience behavior. The analytics engine further provides a comprehensive view of the campaign's performance across all channels, leveraging the blockchain's immutable record to ensure data accuracy and prevent discrepancies between different platforms' reporting. Smart contracts automatically execute payments to publishers and ad networks based on verifiable performance data, with all transactions recorded in the blockchain for transparency. The system and method provides a secure interface where the brand, agencies, and publishers can access the complete, tamper-proof history of the campaign's performance, enhancing trust and accountability in the advertising ecosystem. Machine learning models analyze the blockchain-recorded provenance data to identify the most effective customer journey paths, optimizing future ad placements and budget allocations. The system and method's fraud detection engine, module or process continuously monitors for suspicious acts or pattern in ad interactions, using the blockchain's historical data to establish baseline behaviors and quickly identify anomalies that may indicate bot activity or click fraud. The system and method's cross-platform attribution engine, module or process leverages the blockchain's comprehensive record to accurately track an credit user interactions across different channels and devices, providing a true multi-touch attribution model.

These use cases illustrate how the present system and method use blockchain based provenance tracking, combined with adaptive content generation (for ad and/or publisher content) and cross-platform attribution capabilities. These abilities are novel and useful to enhance transparency, effectiveness and efficiency of digital promotion efforts and placement of digital ad content in corresponding digital publisher content spaces. By providing immutable records of all ad interactions, the invention can address existing challenges in digital advertising. These include but are not limited to data discrepancies, ad fraud, and accurate attribution. This can, inter alia, improve overall campaign performance and return on investment for advertisers, and foster a more trusted and accountable ad ecosystem for all stakeholders.

Therefore, one or more aspects of the invention include: 1) Real-time ad space modification, which dynamically alters ad spaces based on the characteristics of available ads, the target audience, and current market conditions. This is not limited to simple ad placement, but can include actively determining the advertising environment for optimal results. As an example, a standard ad banner may be expanded into an interactive ad space or may modify the layout of a web page to better accommodate a video ad. 2) Synchronized content generation, which can generate both ad content and the corresponding contextual content for the purpose of achieving alignment and relevance between the ad and the content media. 3) Adaptive reinforcement learning, which may be implemented using a reinforcement learning with human feedback (RLHF) and/or reinforcement learning closed loop (RLCL), and which determines strategies having process steps that take into account human insight and automatic optimization. This allows for the system and method to consider objective and subjective quality factors while maintaining scalability and real-time responsiveness. 4) Blockchain-based provenance tracking, which implements an immutable, transparent record of each ad's life cycle on a blockchain. This feature enhances trust, prevents fraud, and facilitates regulatory compliance across the advertising ecosystem. Every step of an ad's development and provision to the ad's user engagement is recordable and verifiable. 5) Cross-publisher attribution, wherein attribution models can track and/or credit user interactions across different publishers and platforms. This provides a view of the engagement of a user or consumer and enables effective budget allocation and even improved performance optimization across multiple facets of the system and method. 6) Privacy-preserving personalization, which can incorporate privacy protections such as federated learning, differential privacy, and zero-knowledge proofs. This further allows for personalized advertising experiences without compromising individual user data, enabling compliance with data protection standards and regulations. 7) Cross-coupled optimization, which comprises mutual interactions between the system and method's matching engine, content generation engine, analytics engine, and blockchain based provenance to establish a feedback loop to dynamically enhance overall system performance. Each component informs and is informed by other components of the system and parts of the process of the invention. The result is a new and useful holistic optimization that can simultaneously takes into account a variety of aspects of the advertising environment and process.

In an aspect, the present system and method provide a novel, adaptive advertising platform and architecture that benefits from machine learning techniques whereby the invention dynamically optimizes both advertisements and their placement contexts and provides transparent, verifiable tracking through blockchains for a trusted solution to digital marketing and online campaigns. The invention is in aspects distinguished over conventional techniques that lack transparency, ad fraud, and accurate attribution. Specifically, in an aspect, the integration of blockchain-based provenance and cross-publisher attribution enables the present invention suitable for operation in strict regulatory environments or environments having high fraud risks.

This disclosure should not be considered limited to the particular embodiments described above. Various modifications, equivalent processes, as well as numerous structures to which the present technology may be applicable, will be readily apparent to those skilled in the art to which the technology is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in field programmable gate arrays (FPGAs) or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a personal digital assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, an intelligent network, or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of the present application need not reside on a single computer or processor, but may be distributed in a modular fashion among a number of different computers or processors to implement various aspects of the present application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the present disclosure includes new and novel improvements to existing methods and technologies, which were not previously known nor implemented to achieve the useful results described above. Users of the present method and system will reap tangible benefits from the functions now made possible on account of the specific modifications described herein causing the effects in the system and its outputs to its users. It is expected that significantly improved operations can be achieved upon implementation of the technology.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

1. A method for optimizing placement of digital advertising content into digital publication content in a secure digital environment, comprising:
over a digital data communication network coupled to a system data interface, receiving input data from a plurality of input data sources, wherein receiving said input data comprises receiving a digital advertising content from a plurality of advertising content in an advertising content pool and further comprises receiving a digital publication content from a plurality of digital publication contents in a publisher content pool;
in a processor of said system, configured and arranged to machine process said input data and stored program instructions, providing said digital advertising content and said digital publication content to a matching engine of said processor, and further determining a match between said digital advertising content and said digital publication content from among the plurality of digital publication contents;
in a content generation engine of said processor, concurrently modifying (a) said digital advertising content to generate a corresponding modified digital advertising content and (b) said digital publication content to generate a corresponding modified digital publication content;
in an analytics engine of said processor, analyzing said modified digital advertising content and said modified digital publication content using one or more reinforcement machine learning models, whereby said modified digital advertising content and said modified digital publication content are determined to meet a programmed matching criterion; and
in a placement module of said processor, placing said modified digital advertising content within a digital environment of said modified digital publication content.

2. The method of claim 1, further comprising provenancing said digital advertising content and said digital publication content, using a secure blockchain infrastructure coupled to said system and data communication network, to provide a respective trusted attribution of each of said digital advertising content and said digital publication content.

3. The method of claim 1, further comprising iteratively determining a system performance metric and repeating the steps of modifying said digital advertising content and said digital publisher content until said performance metric meets a defined value, at which time the modified digital advertising content is placed into the corresponding modified digital publisher content for placement onto a space in said network.

4. The method of claim 1, further comprising iteratively repeating the steps of modifying said digital advertising content and said digital publisher content until a convergence is reached corresponding to an optimum matching and modification of said digital advertising content and said digital publisher content, at which time the modified digital advertising content is placed into the corresponding modified digital publisher content for placement onto a space in said network.

5. A system for securely provenancing and optimally placing a digital advertising content into a digital publication content, comprising:
a data interface placing said system in data communication with a digital data communication network coupled to: an advertising content pool, a publisher content pool, and a blockchain environment wherein content in said advertising and publisher pools is provenanced using said blockchain environment;
a processor, in data communication with said data interface, the processor comprising logic configured and arranged to programmably execute machine-readable instructions, said logic and instructions comprising a content matching engine, an analytics engine and a content generation engine;
said content matching engine coupled and configured to receive said digital advertising content and said digital publisher content and providing an output representing a logical match between said digital advertising content and said digital publisher content;
said content generation engine coupled and configured to receive said digital advertising content and said digital publisher content and output from said analytics engine, to modify at least one of said digital advertising content and said digital publisher content to generate a modified digital advertising content and said modified digital publisher content, respectively;
said analytics engine coupled and configured to receive an output from said matching engine and at least one reinforcement machine learning module and providing an output representing an advertising effectiveness based on said modified digital advertising content and said modified digital publisher content; and
wherein said content generation engine is further coupled and configured to dynamically generate and output a provenanced, optimized and dynamically cross-coupled content comprising said modified digital advertising content and said modified digital publisher content in a space in said digital data communication network.
